(19) United States
(12) Patent Application Publication
(10) Pub. No.: US 2006/0253965 A1
(43) Pub. Date: Nov. 16, 2006

(54) Emesis basin

(76) Inventor: Henry Buermann, Brookfield, VT (US)

Correspondence Address: Kevin Ellicott, Esq., Suite 112, 1 Scale Ave., Ruttland, VT, 05701, US

(21) Appl. No.: 11/125,698

(22) Filed: May 10, 2005

(51) Int. Cl. A61J 19/00; A47K 1/04

(52) U.S. Cl. 4/258

(57) ABSTRACT

An emesis basin for containing fluids comprising a front wall, a left side wall, a right side wall, a rear wall a bottom and an open top, each of the walls having height, and the rear wall height being greater than the front wall height.

### CROSS REFERENCE TO OTHER APPLICATIONS

This is the first submission of an application for this article of manufacture. There are no other applications, provisional or non provisional.

### FEDERALLY SPONSORED RESEARCH AND DEVELOPMENT

There are no federally sponsored or funded research or development projects or undertakings in any way associated with the instant invention.

### BACKGROUND OF THE INVENTION

1. Field of the Invention

The instant invention relates to that field of devices consisting of articles of manufacture known as basins and bowls. Specifically, the instant invention is an improved emesis basin for receiving fluids and preventing accidental spillage.

2. Background Information

The prior art known to the Inventor discloses that the emesis basin is known within the art of medical devices. These basins are most frequently used in hospital and similar settings, to receive fluids and contain those fluids until they are disposed of. As the name suggests, one of the principal uses of the device is to catch and contain vomit. However, it is well known that the basin may be used to catch and contain many other fluids, whether bodily fluid (e.g., urine) or man-made (disinfectant). One example of the use of an emesis basin is the situation where a patient needs to spit out a fluid (or vomit) and cannot get up and move to an appropriate disposal place, such as a bathroom sink or toilet. In such a case, the patient will often be handed an emesis basin and told to spit or regurgitate into the basin. The basin is then emptied into the sink or toilet and either retained for cleaning or disposed of.

While the concept of the emesis basin is generally known, it has also been known that both patients and caregivers are frequently hesitant to use the article. It is not at all unusual for the patient to resist using the emesis basin and instead try to get up and move to the bathroom to use the toilet or sink. Unfortunately, many of the people who will do this are those who under no circumstances should be doing so. They may be weak or groggy, and as a consequence fall and incur additional injuries.

The inventor has discovered that a large part of this resistance to using the emesis basin has been due to the perception that the material which is b eing ejected from the patient, into the basin, has a high likelihood of overflowing the container and being deposited on the caregiver or patient. The inventor has further discovered that this perception is principally due to the apparent dimensions and proportions of the emesis basin.

It is not simply a perception issue. The absence of any means for preventing the overflow of liquids over the rear wall is an actual possibility. Doctors, nurses, and other caregivers have learned through experience that the propulsive force with which vomit strikes the bottom and rear wall of the emesis basin will in fact often result in the ejected fluid overflowing or splashing up and over the rear wall. Having learned that it is possible to be exposed to bodily fluid because of this design flaw, many caregivers will tend to try and turn the responsibility for holding the emesis basin over to the patient, and step away from the situation. This is undesirable too, as the patient often is so concentrated on the action of vomiting or spitting that they are unable to satisfactorily control the emesis basin during the act of regurgitating, and frequently end up spilling the contents of the basin onto themselves.

In short, the emesis basin, as currently manufactured, does not include any means for preventing the fluid which is being deposited therein, from overflowing the rear wall of the container. This critical flaw is therefore addressed by the instant invention.

### SUMMARY OF THE INVENTION

The instant invention is an emesis basin having an upwardly extended rear wall which is preferably higher than the front and side walls. For the first time, the emesis basin includes the means to prevent accidental spillage, splashing or overflow, and therefore both reduces the perception that if the basin is used it will result in fluids being deposited back onto the user or onto the caregiver, and in actuality reduces the potential for that spillage by incorporating an upwardly extended rear wall which tends to prevent the overflow or spillage of said fluids in the direction which the propulsive force of the person depositing the fluids is generally aimed.

A first object of the instant invention, therefore, is to provide for an emesis basin which will instill the user with the perception that the fluid being ejected from the user will not overflow the basin and end up on them.

This objective is accomplished by fabricating an emesis basin having a rear wall which is higher than the front and side walls, and therefore appears less likely to allow spillage over said rear wall, in the direction which the fluids are being ejected from the user.

A second object of the instant invention is to provide for an emesis basin which will in fact prevent the overflow or spillage over the rear wall of the basin.

This objective is accomplished by fabricating an emesis basin having a rear wall which is higher than the front and side walls, and therefore reduces the likelihood that spillage or overflow over said rear wall, in the direction which the fluids are being ejected from the user, will occur.

### A DESCRIPTION OF THE DRAWINGS

FIG. 1 is an overhead perspective view of an improved emesis basin.

FIG. 2 is a bottom perspective view of an improved emesis basin.

FIG. 3 is a partial cross section of an improved emesis basin, showing the lip.

### A DESCRIPTION OF THE PREFERRED EMBODIMENT

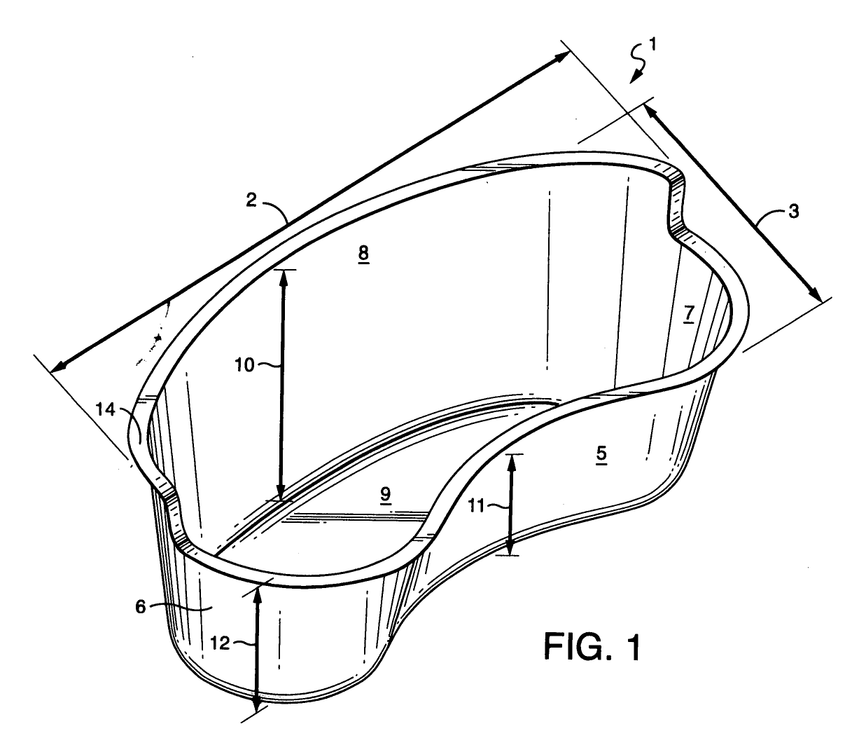

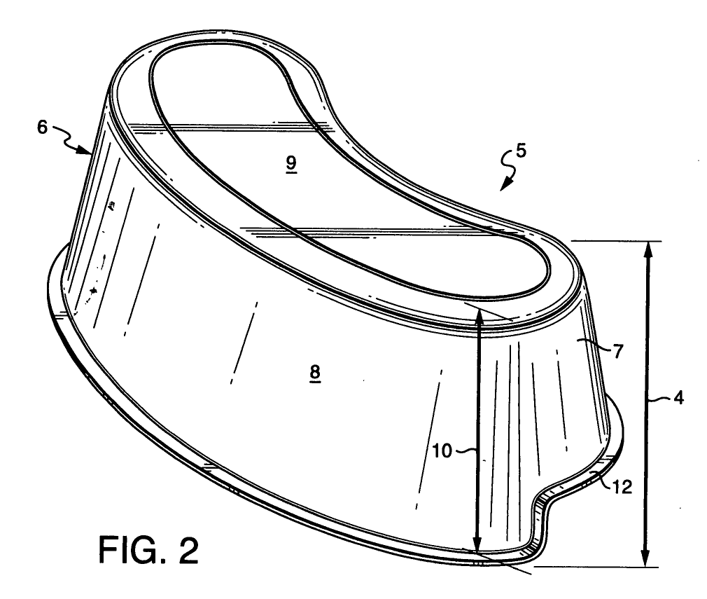

As per FIGS. 1 and 2, in the preferred embodiment an emesis basin (1) is generally “kidney” shaped. This overall form of the basin is well known and accepted throughout the medical instruments art field.

As per FIGS. 1 and 2, the emesis basin has length (2), width (3) and height (4). The emesis basin may further be generally understood to have an upwardly extending front wall (5), an upwardly extending left side wall (6) an upwardly extending right side wall (7), an upwardly extending rear wall (8) and a bottom (9). Obviously the top of the container is open, allowing for fluids to be deposited within the open interior space defined by the front wall, the left side wall, the right side wall, the rear wall and the bottom.

As has been noted, the emesis basin is kidney shaped, however that is not a requirement, it is simply a convention of the art field, and could be varied without departing from the scope of the claims.

Those who practice in the medical devices an field will immediately recognize what the term “kidney” shaped means generally, and specifically in the context of an emesis basin. However, it may be useful to others to explain that the rear wall is radiused outwardly, away from the front wall, the right side wall is radiused outwardly, away from the left side wall, the left side wall is radiused outwardly, away from the right side wall and the front wall is radiused inwardly, towards the rear wall. The front wall merges into the left side wall and the right side wall, the rear wall merges into the left side wall and the right side wall. The left side wall, right side wall, front wall and rear wall all merge into the bottom. Thus, all the walls combined with the bottom form a container (basin) having an open top which is suitable for containing fluids (provided the container is made from a material which does not permit the fluids to escape or soak into the container).

Generally, an emesis basin is fabricated from a resilient, leak-proof and watertight material such as plastic (for example, ABS, styrene or polypropylene) or a metal such as aluminum or stainless steel. The precise material used to fabricate the instant invention is unimportant, so long as it will contain liquids deposited therein, without leaking through or soaking into said material.

It is also understood that an emesis basin may or may not be somewhat tapered from top to bottom, that is, the opening defined by the right side wall, left side wall, front wall and rear wall may be somewhat larger than the dimensions of the bottom, where the right side wall, left side wall, front wall and rear wall meet and merge into the bottom. Whether the emesis basin tapers from top to bottom is unimportant for the functioning of the instant invention, and does not affect the scope of the claims herein.

It is critically important to understand that the height of the rear wall must be greater than at least the front wall, for the instant invention to function as intended. It is the extent to which the rear wall extends upwardly, in relation to at least the front wall, which provides the perception that liquids ejected into the emesis basin will not overflow or splash out of the container, and which in fact helps prevent the splashing or overflowing from actually occurring. The relationship between the height of the rear wall, and the side wall, however, is generally unimportant. The side walls could be constructed to have a height equal to or less than the rear wall. Furthermore, the side walls could have a height greater than or equal to, the front wall height. The precise height of the side walls may be varied relative to the rear wall and the front wall without affecting the scope of the claims.

The precise difference in height between the front wall and the rear wall may be generally varied without affecting the functioning of the instant invention. Furthermore, while it is possible that there be a difference in height only between the front wall and the rear wall, in the preferred embodiment the rear wall has a greater height than left side wall and the right side wall as well. However, as was noted above, while these particular dimensions may be preferred, they are not required for operation of the instant invention. One could just as easily include side walls that had height equal to the rear wall. One could also just as easily have only a portion of each side wall of equal height relative to the rear wall, or of slightly greater or lesser height. What is important is that t least a portion of the rear wall have a height greater than the height of at least a portion of the front wall.

In the preferred embodiment, as per FIGS. 1 and 2, the rear wall height (10) is approximately 3.250 inches, while the front wall height (11) is only 2.500 inches. Furthermore, in the preferred embodiment, the left side wall height (12) is also 2.500 inches, less than the rear wall height. In the preferred embodiment, the left side wall and the right side wall have equal height.

The rear wall height has been chosen to be 3.250 inches because in testing this was optimal. However, this height may be increased or decreased and remain within the scope of the claims. So long as the rear wall height is greater than the front wall height such that materials being ejected into the emesis basin do not overflow or splash over the rear wall, the device will function as intended.

And while no specific measurements should be required to practice the instant invention, and while any measurements provided could easily be varied according to the user's needs, without departing from the scope of the claims, it may be useful to eliminate any need for experimentation when practicing the instant invention by providing the dimensions incorporated into one embodiment of instant invention. Such measurements could include a length (2) of 9.909 inches, a width (3) of 4.857 inches, and a height (4) of 3.250 inches. It is important to note in this embodiment that the height (4) given is that of the rear wall, and not the left side wall, right side wall or front wall. When dimensioned in this fashion, the open interior space of the emesis basin described herein provides a capacity of approximately 32 ounces, or 1000 cubic centimeters. As has been noted earlier, dimensions could easily be varied while still remaining within the scope of the claims that follow.

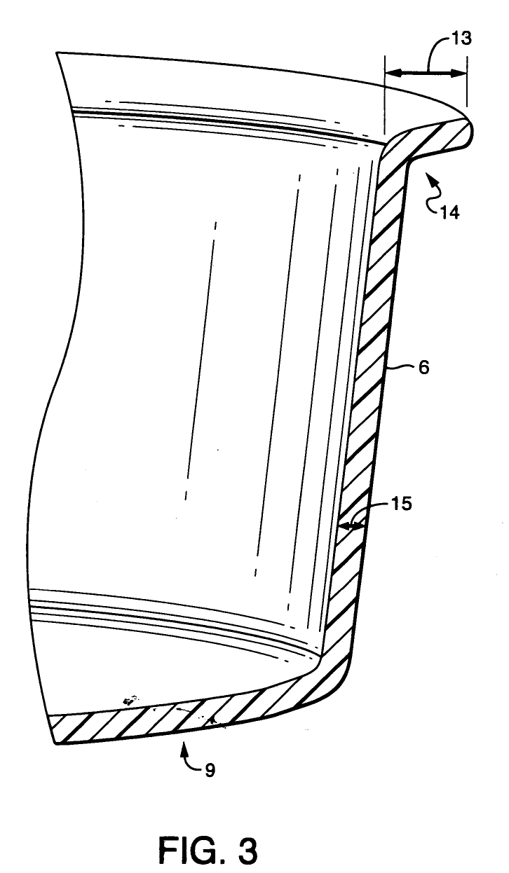

Finally, it may be useful to include an emesis basin lip (12), the lip being located at the top-most portion of the rear wall, right side wall, left side wall and front wall, and being located distally from the bottom. As per FIGS. 1, 2 and 3, the lip is essentially the portion of each of the walls, located most distally from the bottom, which has been bent over at approximately a 90 degree angle such that that portion of each wall is generally horizontally parallel to, though obviously not horizontally co-planar with, the bottom. The precise lip span (13) is unimportant, though in the preferred embodiment the lip extends outwardly and away from each of the walls approximately 0.239 inches.

Finally, it is obvious that the basin must be made of a material having thickness. The precise thickness of the right side wall, left side wall, rear wall, front wall and bottom will largely depend upon the material chosen from which to fabricate the device. The material must be strong enough and thick enough to prevent the basin from warping or bending when filled with liquid and held by, for example, the back wall, between one's fingers. If the material were stainless steel, the thickness could be far less than a weaker material such as Styrofoam. In the preferred embodiment, when fabricated from the preferred material, the right side wall has a thickness (15) of 0.031 inch. Furthermore, in the preferred embodiment all the other walls and the bottom of the device have the same thickness. However, it is entirely possible that these particular thicknesses may be varied from the preferred, and from one another, without departing from the scope of the claims, so long as the device was sufficiently strong and rigid so that it would not bend or warp when liquid was placed within it, thus preventing spillage from the basin due to bending of any of the basin walls or bottom.

Again, dimensions have been provided merely to enable the routineer in the art to practice the instant invention without undue experimentation, and unless specifically stated as being required to practice the device should not be considered in any way limiting when interpreting the claims.

I claim:

1. An emesis basin comprising:
A. A front wall, a right side wall, a left side wall, a rear wall and a bottom,
I. the front wall merging into the left side wall,
II. the front wall merging into the right side wall,
III. the right side wall merging into the rear wall,
IV. the left side wall merging into the rear wall,
V. the front wall, left side wall, right side wall and rear wall each merging into the bottom such that an open container is thereby defined,
B. the front wall having front wall height, the right side wall having right side wall height, the left side wall having left side wall height, the rear wall having rear wall height,
I. the rear wall height being greater than the front wall height.

2. An emesis basin according to claim 1, further comprising:
A. the left side wall height and the right side wall height being greater than the front wall height.

3. An emesis basin according to claim 2, further comprising;
A. The front wall, left side wall, right side wall and rear wall having a lip,
I. the lip having a lip span.

4. An emesis basin according to claim 1, further comprising:
A. The left side wall height and the right side wall height being equal to the front wall height.

5. An emesis basin according to claim 4, further comprising;
A. The front wall, left side wall, right side wall and rear wall having a lip,
B. the lip having a lip span.
